(19) United States
(12) Patent Application Publication
(10) Pub. No.: US 2007/0113166 A1
(43) Pub. Date: May 17, 2007

(54) Method of authoring audiovisual content, audiovisual product, method of producing audiovisual product and apparatus

(75) Inventor: John Duncan Stovin, Thornhill (GB)

Correspondence Address: DAVID E. HUANG, ESQ.;BAINWOOD HUANG & ASSOCIATES LLC, 2 CONNECTOR ROAD, SUITE 2A, WESTBOROUGH, MA, 01581, US

(73) Assignee: ZOOTECH Limited, Sheffield (GB)

(21) Appl. No.: 11/594,715

(22) Filed: Nov. 8, 2006

Related U.S. Application Data
(60) Provisional application No. 60/775,679, filed on Feb. 22, 2006.

(30) Foreign Application Priority Data
Nov. 8, 2005 (GB) 0522779.8

(51) Int. Cl. G06F 17/00; G06F 15/00; H04N 5/44

(52) U.S. Cl. 715/500.1; 715/723; 715/530; 715/716

(57) ABSTRACT

A method of authoring audiovisual content for an audiovisual product finds application in the field of authoring optical disc products, such as DVD-Video, HD-DVD and Blu-ray products. The method includes: providing a plurality of content objects; determining a priority associated with a predicted use of at least one of the content objects in a playback of the audiovisual content; and storing the plurality of content objects and the priority.

### CROSS REFERENCE TO RELATED APPLICATIONS

This patent application claims the benefit under 35 U.S.C. § 119(e) of U.S. Provisional Application No. 60/775,679 entitled METHOD OF AUTHORING AUDIOVISUAL CONTENT, AUDIVISUAL PRODUCT, METHOD OF PRODUCING AUDIOVISUAL PRODUCT AND APPARATUS, the contents and teachings of which are hereby incorporated by reference in their entirety.

### BACKGROUND

The present invention relates to a method of authoring audiovisual content, particularly for an audiovisual product. The present invention further relates to an audiovisual product, a method of producing the audiovisual product, and apparatus for performing playback of audiovisual content.

In general terms, an audiovisual product such as a movie or other presentation is formed by gathering together many small sections or clips of raw audio and visual content. This is usually termed an “authoring” process wherein the raw sound clips, still images and video clips are progressively assembled and edited together to form the finished audiovisual product. The audiovisual product is then recorded on some form of recording media. Traditionally, this would be an analogue medium such as celluloid film or analogue video tape (e.g. VHS format video tape). More recently, it has become possible to record audiovisual content onto random access media including in particular optical disc media, or other forms of random storage such as magnetic hard drives. These random access media have many advantages in terms of size, data capacity, playback speed, image quality and so on.

An optical disc is a convenient storage medium for many different purposes. A digital versatile disc (DVD) has been developed with a capacity of up to 4.7 Gb on a single-sided single-layer disc, and up to 17 Gb on a double-sided double-layer disc. There are presently several different formats for recording data onto a DVD disc, including DVD-Video, DVD-Audio, and DVD RAM, amongst others. Of these, DVD-Video is particularly intended for use with pre recorded video content, such as a motion picture. As a result of the large storage capacity and ease of use, DVD discs are popular and commercially important.

Conveniently, an optical disc, such as a DVD Video format disc, is played using a dedicated playback device with relatively simple user controls. DVD players for playing DVD-Video discs are relatively widespread. More detailed background information concerning the preferred example DVD-Video specification is available from DVD Forum at www.dvdforum.org and elsewhere.

In the future, high definition optical disc players, for example Blu-ray or HD-DVD players, may replace DVD-Video. In addition, or alternatively, holographic versatile disc (HVD) may become widespread. It is expected that other storage formats and other systems will arise from time to time; some relying on optical disc and others relying on other kinds of media, for example magneto-optical, magnetic, solid state or the like.

### SUMMARY

It is an object of the present invention to provide audiovisual content authored to provide enhanced audiovisual content.

In accordance with a first aspect of the present invention, there is provided a method of authoring audiovisual content for an audiovisual product, said method including:

a) providing a plurality of content objects;

b) determining a priority associated with a predicted use of at least one of said plurality of content objects in a playback of said audiovisual content; and

c) storing said plurality of content objects and said priority.

The priority is determined before finishing the authored audiovisual content. A use of at least one of the content objects in the playback is predicted, preferably by simulating at least one playback and monitoring use of at least one of the objects in the simulated playback.

So-called “next generation” DVD formats are being developed and will offer increased functionality over existing DVD formats as well as supporting highly interactive audiovisual content. In next generation formats, data objects, such as video or audio clips, may be used in a playback of audiovisual content. These objects are usually loaded into a cache in the DVD player before use thereof in the playback. Objects are usually distinct from primary audiovisual content in that they are intended to augment rather than replace the primary audiovisual content. As each object may often be re-used during the playback, it is frequently necessary to re-load an object into the cache for each use. For each re-load, the DVD player has to read the object from the DVD. Continual reloading in this way is time consuming and often causes delays in the playback of the audiovisual content, particularly if the object has a large data size. The present invention addresses these issues.

A content object may represent video data, audio data, image data or a program, such as an applet, for use in playback of the audiovisual content.

The priority is indicative of a manner that at least one of the objects should be temporarily stored in an object store, such as a cache, of audiovisual playback apparatus. Storage of content objects in accordance with the priorities ensures that content objects are readily available for use in a playback, thus providing minimum delays in playback.

Preferably, the priority is determined in accordance with a predicted frequency of using at least one of said plurality of content objects in a playback. If the frequency of using one content object in a playback is predicted to be high, that content object will be, for example, assigned a higher priority than a content object having a low priority assigned on a prediction of a low frequency of use. In this way, a content object which is frequently used in a playback is readily available, for example from a cache, for use in the playback, rather than the content object having to be re-read from the audiovisual product for every use in playback. Playback is therefore efficient and re-reading from the audiovisual product is minimized.

It is preferred that the method includes determining an individual priority in step b) for each of said plurality of content objects. The priority for using each content object in playback ensures that each content object is appropriately handled by playback apparatus to ensure that the most efficient playback is provided.

In accordance with another aspect of the present invention, there is provided an audiovisual product comprising a playback-device-readable medium (such as an optical disc as discussed above) with audiovisual content recorded thereon, wherein said audiovisual content includes a plurality of content objects and priority data indicative of a predicted use of at least one of said plurality of content objects in a playback of said audiovisual content. The priority data indicates the predicted use in playback of the content objects and therefore allows the audiovisual content stored on the product to be played back in the most efficient manner.

According to a still further aspect of the present invention, a method of producing an audiovisual product for playback is provided, wherein the method includes authoring in accordance with the invention.

In accordance with a further aspect of the present invention, there is provided apparatus for performing playback of audiovisual content stored by an audiovisual product, wherein said audiovisual content includes a plurality of content objects and priority data indicative of a predicted use of at least one of said plurality of content objects in said playback, wherein said apparatus comprises:

a) a reader arranged to read content objects and respective priority data;

b) an object store arranged to temporarily store one or more content objects; and

c) an object handler arranged, in accordance with respective priority data, to store one or more content objects in said object store and/or to delete at least part of one or more content objects stored in said object store.

The apparatus interprets the priority data and stores one or more content objects in the object store accordingly. The object store is, for example, a cache. The object handler stores one or more selected content objects in the object store and/or deletes at least part of one or more selected content objects from the object store on the basis of the priority data, to ensure that, by storing high priority content objects in the object store more permanently than low priority content objects, the high priority content objects are readily available for use in the playback. Re-reading of the audiovisual product is minimized which provides more efficient playback.

In embodiments to be described, a content object must be stored in its entirety in the cache so as to be available for use in playback. In such embodiments, the situation may arise where a content object is next required for use in the playback, but there is insufficient storage capacity in the object store for the content object. If the content object to be stored has a lower priority than the priority of each object already stored in the object store, at least one of the stored objects would be deleted, despite having a higher priority, to allow storage of the content object. This ensures that the now stored content object is available for imminent use in playback.

Preferably, each content object is stored in the object store before use in the playback. If a maximum storage capacity of the object store, which already stores at least one content object, would be exceeded by storing a further content object, the object handler selects and deletes the stored content object having, for example, the lowest priority. This ensures that the highest priority content objects are readily available for playback without re-reading the product.

The term deleting, used herein, should be taken to include overwriting of at least part of one or more content object stored in the object store, for example with at least part of a further content object.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a schematic representation of an audiovisual product and data stored therein, in accordance with an embodiment of the present invention.

FIG. 2 shows schematically apparatus for authoring audiovisual content, in accordance with an embodiment of the present invention.

FIG. 3 is a flow diagram showing steps for authoring audiovisual content, in accordance with an embodiment of the present invention.

FIGS. 4 (consisting of 4a and 4b) and 5 are flow diagrams showing steps for determining a priority in accordance with embodiments of the present invention.

FIG. 6 shows schematically a playback of audiovisual content and apparatus for performing the playback, in accordance with the present invention.

FIG. 7 is a flow diagram showing steps for performing a playback of audiovisual content, in accordance with an embodiment of the present invention.

FIG. 8 shows schematically a storage of content objects in accordance with time.

### DETAILED DESCRIPTION

In accordance with the present invention, an audiovisual product and audiovisual content will first be described. Methods and apparatus for authoring the audiovisual content will then be detailed, followed by methods and apparatus for playback of the audiovisual content.

Audiovisual Product and Audiovisual Content

Embodiments of the present invention relate to an audiovisual product which is arranged to provide audiovisual content. The audiovisual product may be a record carrier, for example an optical disc playable according to an optical disc format specification. The audiovisual content may be arranged as data to be streamed over a data link from a remote terminal. Audiovisual content may therefore be downloaded by a user on demand from a remote terminal, such as a server, to a local terminal and played back to the user during the download. Alternatively, the complete audiovisual content may be downloaded and stored on the local terminal, before playback.

The audiovisual content includes primary content such as movie content, audio content and image content which may be played back to a user. The audiovisual content also includes a plurality of content objects and priority data indicative of a predicted use of at least one of the plurality of content objects in a playback of the audiovisual content. Each content object may represent one of video data, image data, audio data and a program, for use in playback. The program may count a score during playback, allow a user to modify a playback setting such as an audio or a visual setting, perform an audiovisual effect such as shaking an image, provide a user menu or generate text for the audiovisual playback. A content object may comprise two or more of the foregoing features. The program may be an applet. Further functions of the program which enhance playback of the audiovisual content are also envisaged within the scope of the present invention. The priority data will be described in further detail below.

Preferred embodiments of the present invention will be described below where the audiovisual product is an optical disc in accordance with the DVD-Video specification available from the DVD Forum at www.dvdforum.org and elsewhere, and which is playable on a DVD-Video player. Further details of the DVD-Video format are incorporated herein by way of the reference: “DVD Demystified”, Second Edition, Jim Taylor, Published by McGraw-Hill, 2001.

It will be appreciated that the invention is applicable to a wide variety of other environments, particularly where audiovisual content is stored in some form of random access storage media. Also, it is envisaged that the DVD-Video format will itself be superseded over time and replaced with new format definitions. Hence, the present invention is seen to be applicable in other present and future environments.

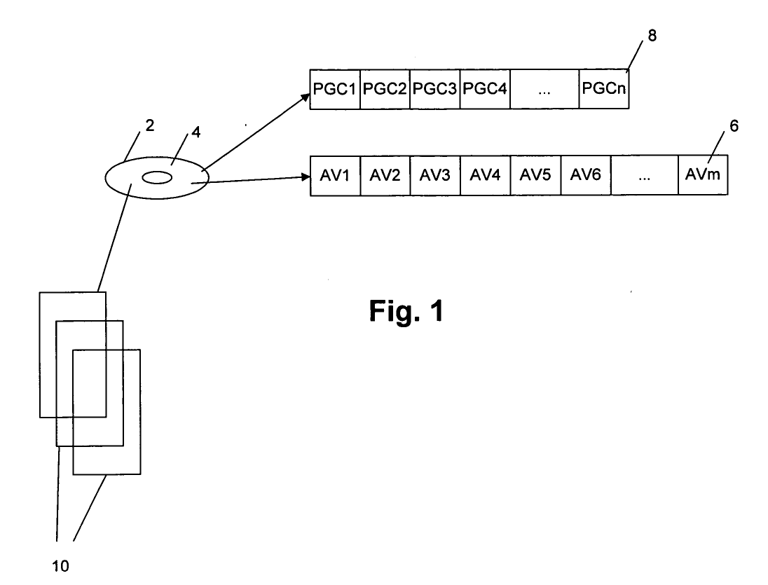

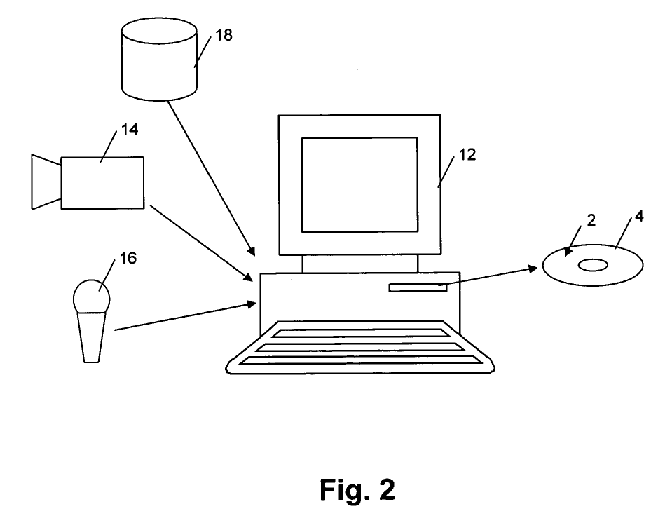

FIG. 1 shows a structure of the audiovisual product 2 in detail. Audiovisual content 4 which includes a plurality of cells 6, in this case represented by cells AV1, AV2 . . . AVm. Each cell 6 contains a short section of audiovisual data, preferably video data for at least one video stream, audio data for at least one audio stream, and sub-picture data for at least one sub-picture stream. The cells are played in sequence, typically one after the other, in order to deliver the intended audiovisual representation, under control of a playback sequence instruction 8. The sequence instructions 8 as shown in FIG. 1 are separate from the cells 6. Suitably, the cells 6 and the sequence instructions 8 are each allocated to structure locations within the audiovisual product, so as to enable navigation between instructions 8 and from instructions 8 to cells 6.

The cells 6 also include at least one content object and respective priority data. In this embodiment there is individual accompanying priority data for each of the content objects. Each individual item of priority data is associated with a respective one of the content objects and the association is stored as a property of the appropriate content object. Alternatively, the audiovisual content may further include association data indicative of the content object which each item of priority data is associated with.

In this embodiment the audiovisual content also includes data copies 10 of each of the content objects, and the respective priority data. It is envisaged that in alternative embodiments of the invention, the audiovisual content does not include such data copies 10.

In the preferred example of DVD-Video format data, the cells 6 are played in sequence through their inclusion by reference in programs (PGs), which are in turn organized into Program Chains (PGCs). In FIG. 1, the sequence instructions 8 are represented by Program Chains PGC1, PGC2 . . . PGCn. In playback, the content objects are arranged to accompany at least one video, audio and/or sub-picture stream which are provided from the audiovisual content. Further detail will be explained below.

Authoring Audiovisual Content

FIG. 2 shows an example authoring apparatus as employed in preferred embodiments of the present invention for authoring the audiovisual content. In this embodiment, the authoring apparatus includes a computing platform such as a client-server computer system, or a stand-alone personal computer 12. Optionally, raw audio and video data are received, such as through a camera 14 and a microphone 16, or are provided from other sources such as a file storage device 18, or are generated within the authoring apparatus such as by image and sound creation software. The raw content data may include video clips, audio clips, still picture images, icons, button images and other visual content to be presented onscreen. The content is suitably in the form of MPEG or JPEG encoded files, but may take any suitable format.

The authoring apparatus creates a navigation structure for the desired audiovisual product. The finished audiovisual content 4 is written onto a storage medium such as a magnetic hard disc drive within the personal computer 12 or, preferably, onto an optical disc so as to produce the audiovisual product 2. In this embodiment the audiovisual product is playable according to an optical disc format specification, such as DVD-Video. The audiovisual product may therefore be produced according to this method, although further methods of production are envisaged. For example, for mass production of an optical disc, a master optical disc storing the audiovisual content may first be produced, followed by producing a plurality of optical discs copied from the master disc.

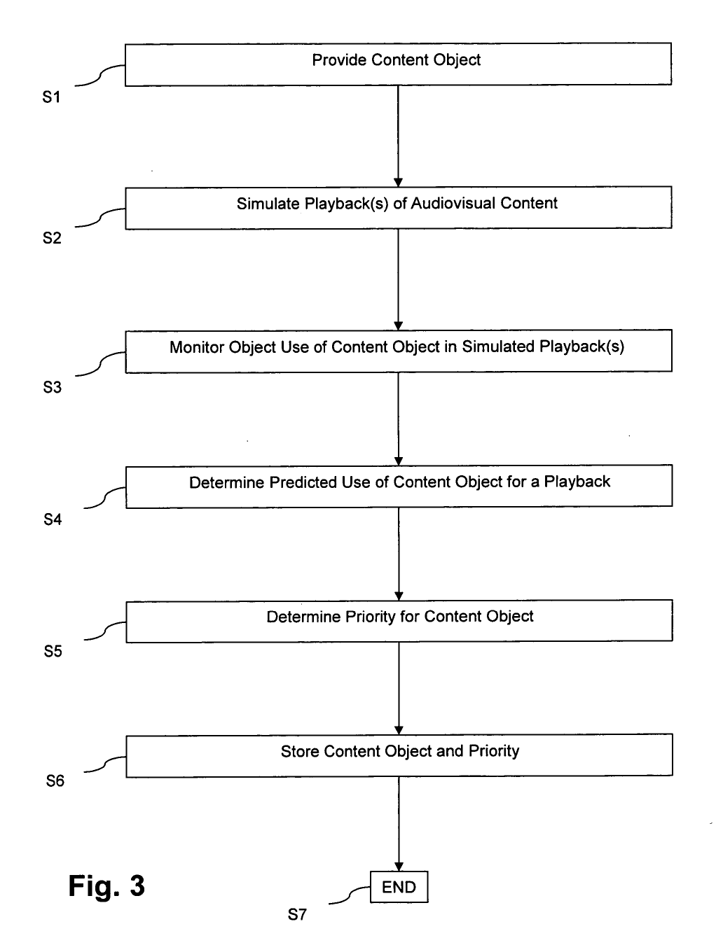

A method of authoring audiovisual content, implemented by a computer, will now be described with reference to FIG. 3.

The authoring may be performed manually by an author using the authoring apparatus described above. Parts of the authoring may also be performed automatically, particularly routine authoring processes, for example by the personal computer 12.

Firstly, a plurality of content objects is provided, in step S1. For clarity, FIG. 3 refers to only one content object; however, the steps of FIG. 3 are repeated for each of the plurality of content objects. Where a content object is audio, video or image data, at least one object may be generated or provided from raw data, as described above, or may be obtained from a library of content objects. If the content object is a program, program code may be written and saved as a program content object, or a pre-written program content object may be used.

For at least one of the provided content objects, a priority is determined. In this embodiment an individual priority is determined for each of the content objects. The priority may be determined according to many different methods, as will be described below.

In this embodiment, the priority is determined by simulating at least one playback of the audiovisual content. For a playback to be simulated, trial audiovisual content needs to have been authored which includes all audio data, video data, sub-picture data and the content objects of the audiovisual content, but which does not yet include priority data. A simulated playback involves performing playback of the trial audiovisual content, in step S2, and monitoring use of the content object, in step S3, of at least one of the content objects in the simulated playback. In some embodiments, each simulated playback corresponds with a particular navigation path through the navigation structure of the audiovisual content. For example, in the case of an interactive quiz or adventure game, a different sequence of user interactions or selections may be possible each time the quiz or game is played, and each simulated sequence in a simulated playback may provide a different navigation path of the navigation structure.

In accordance with the monitored object use, a predicted use is determined, in step S4, of each of the content objects for a playback of finished audiovisual content. Next, a priority is determined, in step S5, for the content object on the basis of the predicted use. Thus, a priority is determined which is associated with the predicted use of at least one of the plurality of content objects in the playback of the audiovisual content.

The content object and the determined priority are then stored, in step S6, and the determination of the priority ends, in step S7. In this embodiment the content objects and the respective priorities, associated with the appropriate content object, are stored on the magnetic hard disc of the personal computer 12, or onto a record carrier such as an optical disc. The stored audiovisual content with the associated priorities, stored as priority data, for each content object constitutes at least part of the finished audiovisual content.

In embodiments of the present invention, a plurality of playbacks may be simulated. The object use of at least one of the plurality of content objects in one of the plurality of simulated playbacks is different to the object use of the same at least one content object in a different one of the plurality of simulated playbacks. An object use of each of the content objects is therefore determined for each simulated playback, so that a priority can be determined for each content object.

For each simulated playback, the object use of each content object is monitored. For each simulated playback, therefore, a combination of individual object uses is determined, where each individual object use corresponds with use of a different one of the content objects. It is possible to determine a number of playbacks which need to be simulated so that a total number of different possible combinations of individual object uses is achieved.

The number of playbacks which are simulated may therefore be equal to the total number of different possible combinations of objects uses which are determinable for the plurality of simulated playbacks. In this way, as all possible object uses for each of the content objects are simulated, the accuracy of the predicted use is high, and the determined priority for each content object is consequently high.

For alternative embodiments, the number of playbacks which are simulated is less than a total number of different possible combinations of object uses which are determinable for the plurality of simulated playbacks. Simulating a number of playbacks which is less than the total number of combinations may allow the predicted use, and consequently the priorities, to be determined more rapidly. Each simulated playback is characterized by a particular different combination of object uses.

When the number of simulated playbacks is less than the total number of different possible combinations, the playbacks for simulation, which includes the number of playbacks selected for simulation and/or the actual playbacks selected for simulation (which corresponds with a particular combination), may be selected arbitrarily, for example by selecting the first playback simulation of a list of possible playback simulations, and/or according to a statistical and/or stochastic technique and/or according to an anticipated behavior of a user when performing a playback, for example a playback which is predicted to be performed more often than a different playback.

Selection of the number of playbacks for simulation, selection of the actual playbacks for simulation and/or simulation of the playbacks themselves may be performed automatically, for example by the personal computer 12, may be performed manually, for example by a user, or may be performed partly automatically and the remaining part performed manually.

The predicted use is determined for each of the content objects once all the playbacks have been simulated. For each content object, an average object use, for the plurality of simulated playbacks, may be determined for each content object. The priority is then determined in accordance with the predicted use.

Alternatively, the priority may be determined in accordance with a statistical or a stochastic technique such as a Monte Carlo technique, where the statistic or stochastic technique is applied, for each content object, to the object uses for all of the playbacks which were simulated, so as to determine the predicted use of each content object in a playback. For example, a Monte Carlo technique may be used whereby five hundred randomly selected playback paths may be simulated out of a possible ten thousand playback paths. In such a case, it is expected that the object use for each content object, averaged over five hundred simulated playbacks, would be representative of the average object use over all ten thousand possible playback paths.

Determining the priority may include weighting an object use of at least one particular content object for a certain simulated playback. The priority is then determined in accordance with the weighted object use. If a particular simulated playback is considered more important than a different simulated playback, for example, if one playback by a user is anticipated to be performed more commonly than a different playback, it may be desirable to weight the object use for the more important simulated playback so that the weighted object uses have a greater influence on the priority determination than the influence of a non-weighted object use for a different simulated playback. A weighting may alternatively be assigned in accordance with a data size of a content object.

Priority determination criteria may be used to determine the priority for a content object. The priority determination criteria identifies the priority that should be determined for each of the content objects. The priority determination criteria may have been generated prior to simulating the playbacks, or may, alternatively, have been generated by a user of the authoring apparatus, following a review of the object use of each content object in each of the simulated playbacks. Further alternatively, the priority determination criteria may be generated automatically, using, for example, a predetermined algorithm which operates on object use data obtained for each simulated playback. A priority may be an integer where a low value integer, such as 1, represents a high priority and a high value integer, such as 5, represents a low priority. Each priority could, for example, be represented in the audiovisual content as an 8-bit data value.

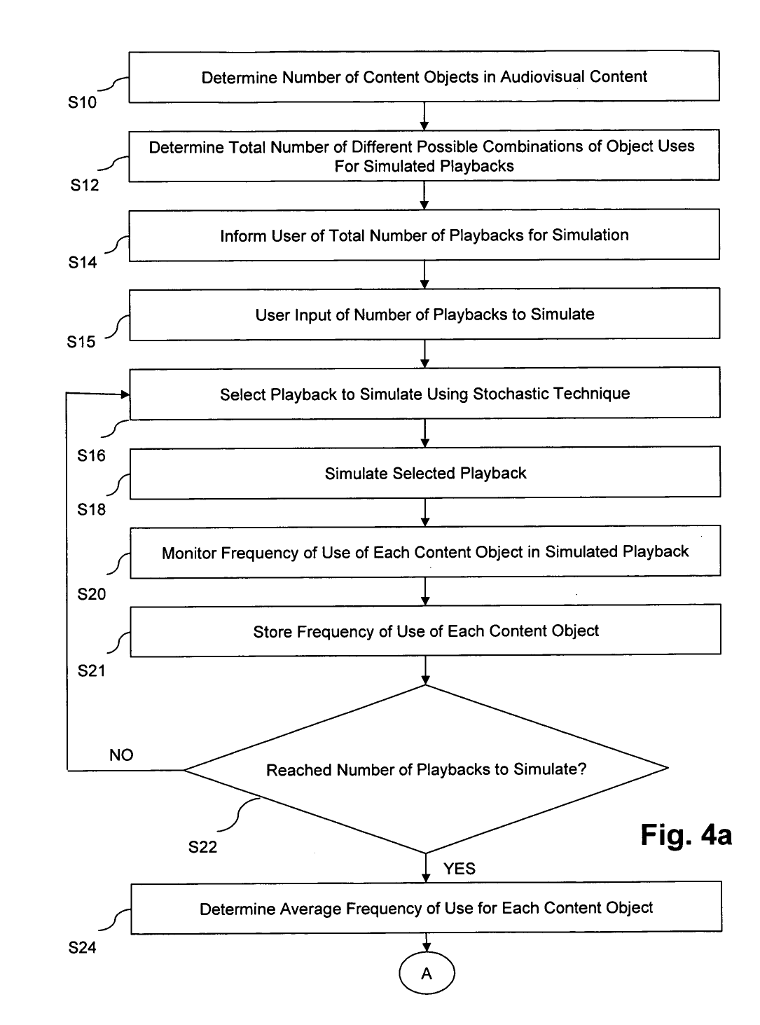

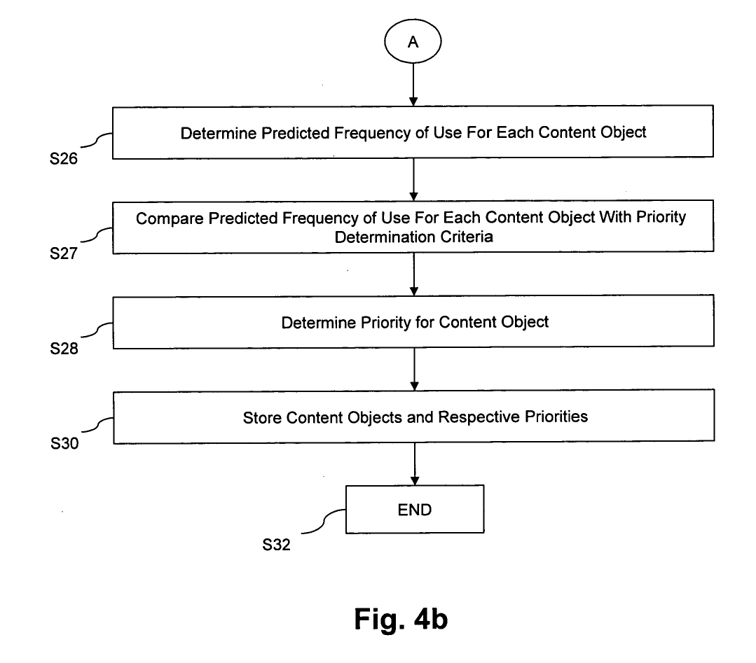

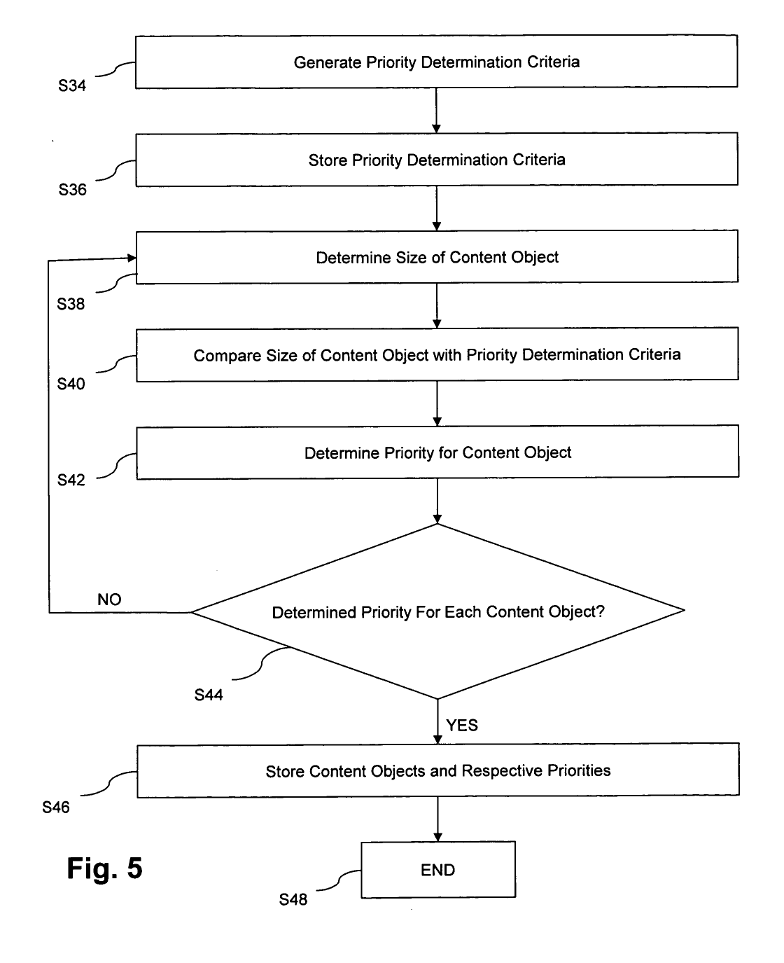

In embodiments of the present invention, the priority may be determined in accordance with a predicted frequency of using at least one of the plurality of content objects in a playback. An example of such an embodiment will now be described with reference to FIG. 4.

### EXAMPLE 1

Firstly, the number of content objects in the trial audiovisual content is determined, in step S10. Using this number of content objects, the total number of different possible combinations of object uses, as described previously, is determined for the simulated playbacks, in step S12, and subsequently informed to the user of the authoring apparatus, in step S14, for example by visual presentation. The user provides input to the authoring apparatus, in step S15, indicative of the number of playbacks which should be simulated. In this embodiment, the number of simulated playbacks is less than the total number of different possible combinations. The user may choose the number of playbacks according to selection criteria such as a predetermined fraction of the total number of combinations, or a predetermined time period in which the playbacks must be simulated within. Further selection criteria are envisaged.

On the basis of the number of playbacks to be simulated, the authoring apparatus automatically selects a first playback for simulation using a stochastic technique, in step S16, and simulates the selected playback, in step S18. The frequency of using each of the content objects in the simulated playback is monitored, in step S20. The frequency of using each content object in the simulated playback is stored by the authoring apparatus, in step S21.

If the number of playbacks to be simulated has not yet been reached, in step S22, a second playback is selected for simulation, in step S16, as described previously. In a similar manner to the first simulated playback, the second playback is simulated, the frequency of using the content objects monitored and subsequently stored. Further playbacks are simulated in this manner, and frequency of use data stored until the number of simulated playbacks reaches the selected number of playbacks for simulation.

An average frequency of use is determined, in step S24, for each content object, which is an object use averaged over all of the simulated playbacks. For example, if there were three simulated playbacks, and a particular content object was used 6 times in the first simulated playback, 2 times in the second simulated playback, and 4 times in the third simulated playback, the average frequency of use would be 4 times for that content object.

The predicted frequency of use of each content object is determined, in step S26, in accordance with the average frequency of use, and may be identical to the average frequency of use. In step S27, the predicted frequency of use for each content object is compared with priority determination criteria in order to determine the priority, in step S28, for each content object. In this embodiment, the priority determination criteria consists of ranges of predicted frequencies of use, where each range of predicted uses corresponds with a particular priority. In accordance with the example given for the three simulated playbacks, if a content object has a predicted frequency of use in the range of 0-2 times, 3-4 times, or 5-6 times, the priority is determined as priority 3, 2 or 1, respectively. In this embodiment the priority is an integer, where the integer 1 is the highest priority and the integer 3 is the lowest priority.

Once the priority has been determined, the content objects and their respective priorities are stored, in step S30, as the finished audiovisual content, as described earlier. The priority determination then ends in step S32.

In accordance with further embodiments of the present invention, it may not be necessary to simulate any playbacks of the trial audiovisual content. For example, priorities of at least some of the content objects may be determined by analyzing the navigation structure of the audiovisual content.

In accordance with one embodiment of the present invention, the priority may be determined in accordance with a data size of at least one of the plurality of content objects. Content objects having a large data size take a long period of time to read from the audiovisual product in a playback and it is therefore preferable to maintain storage of content objects having a large data size in an object store, such as a cache of playback apparatus, to avoid playback delays due to reloading of the content objects into the object store. Playback apparatus will be described in further detail later. Content objects with a large data size are therefore assigned a high priority to ensure that such content objects are stored in the object store as long as possible. Further details of the object store will be given later. An example of such an embodiment will now be described with reference to FIG. 5.

### EXAMPLE 2

In this embodiment, priority determination criteria are firstly generated, in step S34, for example by determining the data size of each of the content objects and determining a set of ranges of data sizes, which each correspond with a particular priority. For example, the priority determination criteria might state that a content object with a data size in the range of 0-250 kb, 251 kb-450 kb or 451-650 kb, would be assigned the priority 3, 2 or 1, respectively. In this embodiment, each priority is an integer where a low value integer represents a high priority and a high value integer represents a low priority.

The generated priority determination criteria is stored, in step S36, for example on the hard disc of the personal computer 12. The data size of one of the content objects is then determined, in step S38, and compared with the priority determination criteria, in step S40. As an alternative to determining the content object size in step S38, the data size of each content object may have been stored following the determination of the data size used for generating the priority determination criteria, in step S34. These stored data sizes would be referenced to determine the data size of each content object, in step S38.

In step S42, a priority is determined for the content object, based on the comparison of step S40. It is determined, in step S44, whether a priority has been determined for each of the content objects. If not, the data size of a further of the content objects is determined, in step S38, and the priority is determined in accordance with steps S40 and S42, as described previously. For the exemplary priority determination criteria, if the audiovisual content includes a first content object, a second content object and a third content object with a data size of 200 kb, 400 kb and 600 kb, respectively, the determined priorities would be 3, 2 and 1, respectively.

Once a priority has been determined for each of the content objects, the content objects and respective associated priorities are stored, in step 46, to produce the finished audiovisual content. Storage may be, for example, on the hard disc of the personal computer 12, or on an optical disc, as described previously. The determination of the priorities then ends, in step S48.

In accordance with the present invention, computer software is provided for performing the method of authoring the audiovisual content, as described hereinbefore. The computer software may be provided on a data carrier, such as an optical disc.

Playback of Audiovisual Product

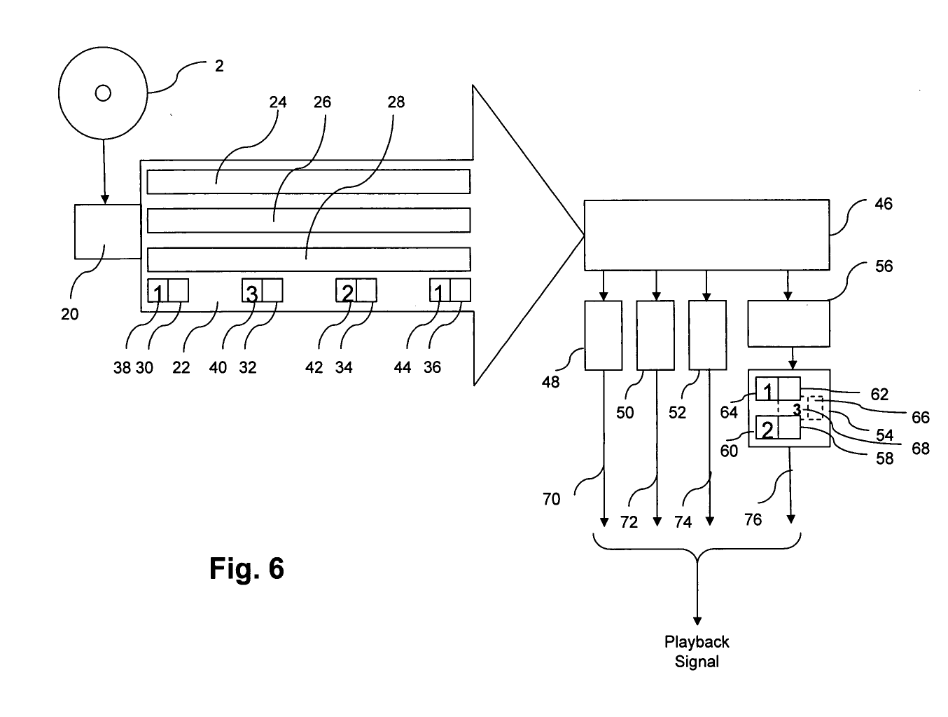

FIG. 6 shows schematically a playback of the audiovisual content and parts of apparatus for performing the playback, in accordance with the present invention.

Apparatus for performing playback of the audiovisual content stored by the audiovisual product comprises a reader 20 arranged to read the audiovisual product 2, in this example an optical disc, in order to provide a data stream 22 of the audiovisual content in digital form. The reader can read each cell 6 to provide at least one video stream 24, at least one audio stream 26 and at least one sub-picture stream 28. The reader can also read, separate from the data stream 22, content objects 30, 32, 34, 36, and respective priority data 38, 40, 42, 44 from the audiovisual product. The priority associated with a particular content object is illustrated in FIG. 6 by locating the content object adjacent the respective priority data.

In this embodiment the reader 20 includes a read head for scanning the optical disc 2 with a radiation beam, and a detector for detecting audiovisual data in the radiation beam, following irradiation of the disc 2. The reader 20 may further include any components which are required to provide the audiovisual content in digital form.

The apparatus comprises a stream buffer 46 which buffers the data stream 22 and a video stream buffer 48, an audio stream buffer 50, and a sub-picture stream buffer 52. In playback, the data stream is demultiplexed and the video stream 24 is buffered by the video stream buffer 48, the audio stream 26 is buffered by the audio stream buffer 50 and the sub-picture stream 28 is buffered by the sub-picture stream buffer 52.

The apparatus further comprises an object store 54 arranged to temporarily store one or more content objects, and an object handler 56 arranged to store, in accordance with respective priority data, one or more content objects in the object store 54 and/or to delete at least part of one or more content objects stored in the object store 54. In this embodiment the object store 54 is a cache and the object handler 56 is arranged to store each one of the content objects in the cache 54, and to delete, in accordance with the respective priority data, one or more content objects from the cache 54. Storing a content object in the cache 54 makes the content object available for use in playback. In preferred embodiments, an object must be stored in its entirety in the cache 54 before it becomes available for use. This distinguishes the cache 54 from a buffer, which typically only ever holds a small fraction of a stream being played. FIG. 6 illustrates, by way of example, that the cache 54 stores one content object 58 having a priority 60 of “2” and one content object 62 having a priority 64 of “1”. FIG. 6 also shows deletion (indicated by dashed lines) of a content object 66 having a priority 68 of “3” from the cache 54. Further details of storage and deletion of the content objects will be described later.

The apparatus is arranged to provide a playback signal, comprising at least one of a video signal 70 from the video stream buffer 48, an audio signal 72 from the audio stream buffer 50, a sub-picture signal 74 from the sub-picture stream buffer 52 and a content object 76 signal from the cache 54. If a content object is an applet, playback of the content object includes execution of the applet. If a content object provides audio and/or video content, playback of the content object includes combining the played back audio and/or video content of the content object with the played back audio and/or video streams, respectively. The playback signal is used by a display system and audio system to present the audiovisual content to a user.

The apparatus further comprises any components necessary to provide playback of the audiovisual content to a user. A controller, such as a central processing unit (CPU), is used to control the use of the video, audio and sub-picture streams for the playback. A demultiplexer may access a track buffer and, using a decoder and/or buffers, provide a signal suitable for the display system and audio system.

Further, the apparatus may include a controller, such as a remote control, for a user to provide input to the apparatus for interaction with the audiovisual content. The input might, for example, be a command to display a menu for modifying playback settings, or may be a command to select a chapter of the audiovisual content.

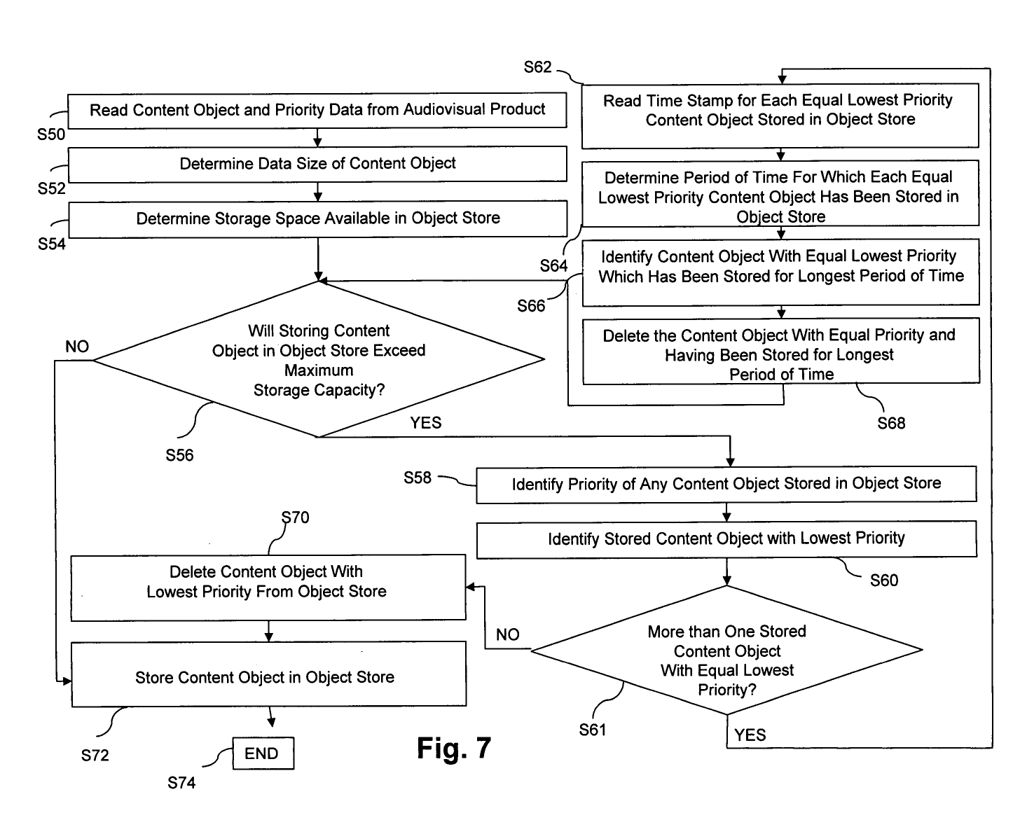

A method of processing content objects in a playback of the audiovisual content performed by the playback apparatus, in accordance with the present invention, will now be described with reference to FIG. 7.

For each of the plurality of content objects, the reader 20 reads, in step S50, one content object and the respective associated priority data from disc 2. A plurality of read content objects form a stream of content objects in accompaniment with the video, audio and/or sub-picture streams 24, 26, 28.

Prior to temporarily storing in the cache 54 the content object read from the audiovisual product, the data size of the content object is determined, in step S52. The cache 54 has a maximum object storage capacity. In the example given with reference to FIG. 6, the cache 54 stores two content objects 58, 62. The apparatus determines the storage space available in the cache 54, in step S54. It is then determined, in step S56, whether storing the read content object in the cache 54, which already stores at least one content object, would cause the maximum object storage capacity to be exceeded.

If the maximum object storage capacity would be exceeded, the priority of each of the plurality of content objects stored in the cache 54 is identified, in step S58, and the stored content object which has the lowest priority is identified, in step S60. If more than one content object stored in the cache 54 each have the lowest priority, i.e. they have equal lowest priorities, determined in step S61, a time stamp of each of these content objects having equal lowest priorities is read, in step S62. In this example, the apparatus is arranged to record a time stamp for each content object stored in the cache 54, the time stamp indicating a time when the corresponding stored content object was stored in the cache 54.

By identifying the present time, the apparatus determines the period of time for which each of the stored content objects, with equal lowest priorities has been stored, in step S64. The content object with the equal lowest priority and which has been stored in the cache for the longest period of time is identified, in step S66, and deleted, in step S68, from the cache 54 by the object handler 56.

It is then determined again, in step 56, whether storing the read content object would exceed the maximum storage capacity. If this will be the case, at least one further content object is deleted, in accordance with the method just described for steps S58 to S68 until storing the read content object will not exceed the maximum storage capacity.

If, in step S61, there is only one stored content object with the lowest priority, i.e. stored content objects have respectively different priorities, the object handler 56 deletes the lowest priority content object from the cache 54, in step S70. As illustrated in FIG. 6, the deleted content object 66 has the priority 68 of “3”, which is lower in priority than the priorities 60, 64 of the stored content objects 58, 62, respectively.

Once there is sufficient storage space in the cache 54, the read content object is stored, in step S72, in the cache 54. Note that, if in step S56, storing the read content object would not exceed the maximum storage capacity, the read content object is then stored in the cache, in step S72. In step S74, the processing of the content objects for the purpose of storage in the cache, ends.

In further embodiments the use of a time stamp, as described above, may be optional. As an alternative, the content object with equal lowest priority selected for deletion from the cache 54 may not be selected in accordance with a time stamp, but is selected according to its data size. For example, the content object having the greater data size of two content objects having equal lowest priorities and stored in the cache 54 is selected for deletion. Further alternatively, a stored content object may be selected arbitrarily for deletion from the cache 54. For example, one of two stored content objects having equal lowest priorities may be arbitrarily selected for deletion.

Further alternatively, during the authoring stage, the priority of each content object may have been determined to be different from the priority of all of the other content objects. In this way, no two priorities can be equal and it is unnecessary for the apparatus to select an object from at least two objects with equal lowest priorities. The stored content objects are used to provide a playback signal in the playback, as described previously.

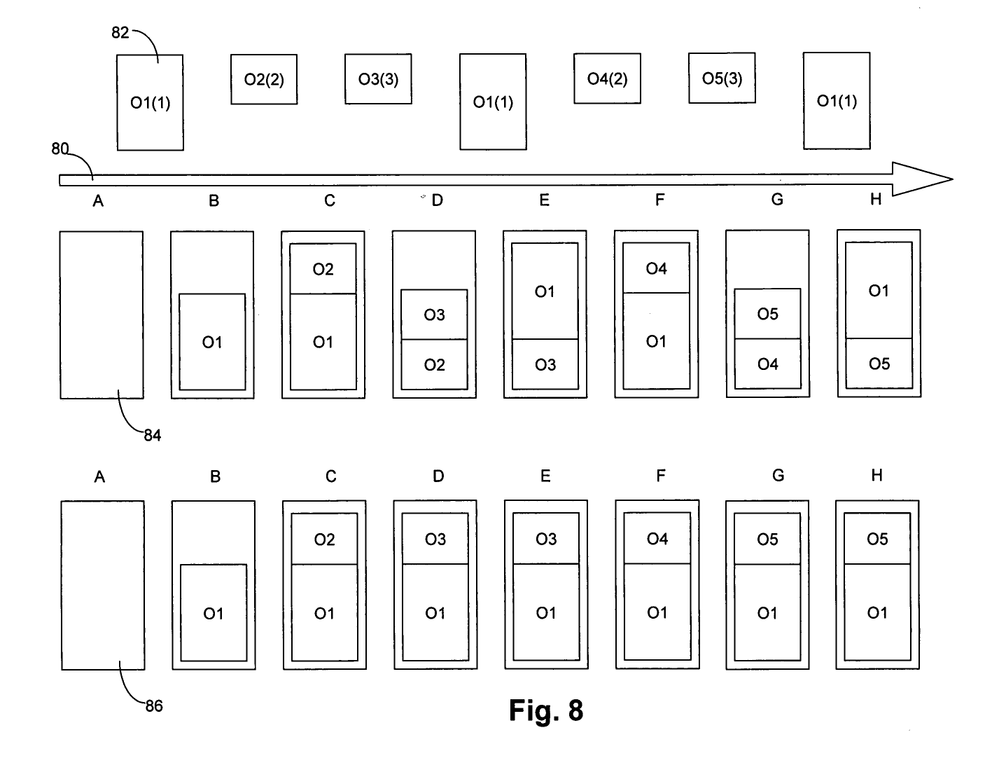

A potential problem addressed by embodiments of the present invention relates to so-called ‘thrashing’, which might occur if content objects that need to be re-used are not readily available for use. The problem is illustrated in FIG. 8, wherein five exemplary content objects 82 are identified as O1-O5, which are arranged along a timeline 80. The position of each object along the timeline is intended to generally coincide with a point in time before the respective object may need to be used.

A first object store 84 is illustrated in eight different states thereof along the timeline, at eight different points in time denoted A-H. For example, at point A, the store is empty, at point B the store contains object O1 and at point G the store contains objects O4 and O5. Objects are loaded into the first store 84 as they are required and are deleted, to make way for new objects, on a first-in-first-out basis; where an object can only be used once it has been stored in the object store 84.

In particular, as shown in FIG. 8, a first occurrence of object O1 is loaded into the store 82 at time B. Then, object O2 is loaded into the store 84 at time C. At time D, object O3 is loaded into the store 84, whereby object O1 is deleted in order to make space for object O3. At time E, object O1 is loaded into the store. At time F, object O4 is loaded into the store, requiring object O3 to be deleted and at time G object O5 is loaded into the store, requiring object O1 to be deleted again. Finally, at time H, object O1 is, again, loaded into the store, requiring deletion of object O4.

In this example, the object O1 may be used up to three times and, hence, is loaded into the store three times. There are a number of ways to facilitate this requirement. First, the object may be stored in the audiovisual content stream three times in advance of its being used, so that it is encountered in the stream and stored in the store three times. If an object needs to be available for use many times, however, storing a commensurate number of occurrences of the same object in the stream might be perceived as a waste of storage space. Alternatively, the object may be stored fewer times than it is needed, or in the limit only once. In this case, there may be an undesirable overhead associated with locating and re-reading the object, if it is not in the object store when needed. Repeatedly locating and re-reading an object in this way, even if the object is a data copy 10, is referred to herein as ‘thrashing’, since such re-reading requires (1) data streaming to cease, (2) a read relocate followed by (3) reading the required object and finally followed by (4) a read relocate to return to the point where streaming ceased in order to continue data streaming.

A way to avoid thrashing is illustrated by a second object store 86, wherein objects are not deleted on a first-in-first-out basis, according to embodiments of the present invention. Instead, objects are deleted according to an assigned content object priority, which is shown as a number in parentheses for each object 82. The priority information for each object is assigned during an authoring stage of audiovisual content production, as described hereinbefore. As shown, object O1 has a priority “1”, object O2 has a priority “2”, object O3 has a priority “3”, object O4 has a priority “2” and object O5 has a priority “3”. In this example, a lower number signifies a higher priority.

At time A, the second object store 86 is empty. At time B, object O1 is encountered and loaded into the store 86. At time C, object O2 is encountered and loaded into the store along with object O1. At time D, object O3 is encountered, requiring object O2 to be deleted to make space for object O3. Object O2 is deleted, even though object O1 was first in, since the priority of object O1 is higher than that of object O2. At time E, object O1 is already in the store so need not be read again. At time F, object O4 is encountered and stored, requiring deletion of object O3. Object O3 is deleted, even though object O1 was first in, since the priority of object O1 is higher than that of object O3. At time G, object O5 is encountered and stored in place of object O4 and at time H object O1 is already in the store so need not be read again.

In this simple example, relating to the second object store 86, it is clear that no thrashing occurs, since, even though object O1 is required three times, it remains in the object store 86 due to its highest priority and never needs to be re-read. Obviously, practical examples may involve far more objects and a far greater range of priorities that can be assigned to the objects.

In this way, each content object is generally read in advance of being required in the playback of the audiovisual content so that the content object will be stored in the cache 54 ahead of the moment when it is required. Each content object is stored by the audiovisual product so that, by reading the audiovisual content to provide the data stream 22, each content object is read in a sequence corresponding to the first time when each content object is required in the playback. Often a content object is re-used in a playback and storing content objects in the cache 54 in accordance with their priorities, as described, maximizes an availability of the content object for use in the playback, without having to reload the content object into the cache 54.

There may be occasions; however, when a content object needs to be re-used in the playback, but is no longer stored in the cache 54, as it has been deleted by the object handler 56. In such circumstances the reader 20 reads the data copies 10 of the disc 2 to retrieve the required content object, and the required content object is stored in the cache, in accordance with the method described with reference to FIG. 7. Delays in playback are minimized as locating the content object for re-use from the data copies 10 is quicker than locating the content object in the audiovisual cells 6, which would involve reading the data stream containing the desired content object from the start of the data stream until the content object is located.

One example where this situation may occur is where a user selects a chapter of audiovisual content for playback, without having played back preceding chapters. Any content objects which would have been loaded into the cache during playback of the previous chapters may not therefore be available in the cache for use in playback of the selected chapter. In this case, the required content objects for the selected chapter are retrieved from the disc 2 so as to be loaded into the cache 54.

The above embodiments are to be understood as illustrative examples of the invention. Further embodiments of the invention are envisaged.

For example, the audiovisual apparatus may be arranged to read audiovisual content from different formats of audiovisual product, such as to read content from a data stream. The data stream may be provided over a data link from a remote terminal and, in these cases, the apparatus would comprise a receiver arranged to receive the data stream transmitted from the remote terminal. Further alternative formats of the audiovisual product may be a compact disc (CD), a magnetic hard disc drive, a digital network or solid state memory. It is envisaged that different parts of the audiovisual content may be provided as different formats of audiovisual product.

Embodiments have been described where each content object of the audiovisual content is stored in the cache prior to use in a playback. Further embodiments are envisaged where it is not necessary to store a content object in the cache prior to playback. In such a case the object handler may be arranged to select only a proportion of content objects for storage in the cache, in accordance with the priority data. In this way, only content objects having a high priority, for example, indicative of a high frequency of use in a playback, and/or indicative of an imminence of use in a playback, may be stored in the cache, whilst content objects with a low priority are not.

The use of a content object in a playback has been described. Use in a playback includes use of a content object during the playback, but also any use which is required in advance of, or after completion of, the playback.

The audiovisual content authored in accordance with the present invention has a large number of applications. For example, the audiovisual content may provide a quiz game and content objects may be commonly used audiovisual elements of the quiz game, such as a “Correct” text image, an “Incorrect” text image, a sound effect of clapping, a current score generated throughout the quiz game, and/or text generated to display the score to a user. Such images, sound effects or scores might be superimposed onto the playback of the audiovisual content without interrupting playback of the audiovisual content. Alternatively, content objects may provide applications or functionality, for example an on-screen menu that is superimposed over a film or the like during playback. Such a menu may be displayed in response to a user control and provide the facility to control playback options of the playback equipment, for example sound or video playback options, without the need to pause the playback of the film. Such a menu may alternatively provide the facility for user interactions with content that is being played, for example to answer questions in a quiz, jump to different chapters or select different endings or the like.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method of authoring audiovisual content for an audiovisual product, said method including:
a) providing a plurality of content objects;
b) determining a priority associated with a predicted use of at least one of said plurality of content objects in a playback of said audiovisual content; and
c) storing said plurality of content objects and said priority.

2. A method according to claim 1, wherein determining said priority in step b) includes simulating at least one playback of said audiovisual content; monitoring an object use of at least one of said plurality of content objects in said simulated playback; and determining said predicted use in accordance with said monitored object use.

3. A method according to claim 2, wherein a plurality of said content objects are used in each of a plurality of simulated playbacks and a priority of each of said plurality of content objects is determined for each simulated playback.

4. A method according to claim 3, wherein a number of playbacks which are simulated is equal to a total number of different possible combinations of object uses which are determinable for said plurality of simulated playbacks.

5. A method according to claim 3, wherein a number of playbacks which are simulated is less than a total number of different possible combinations of object uses which are determinable for said plurality of simulated playbacks.

6. A method according to claim 5, wherein playbacks for simulation are selected arbitrarily.

7. A method according to claim 5, wherein playbacks for simulation are selected in accordance with a statistical technique.

8. A method according to claim 5, wherein playbacks for simulation are selected in accordance with a stochastic technique.

9. A method according to claim 2, wherein said at least one simulated playback is performed automatically.

10. A method according to claim 2, wherein said at least one simulated playback is performed manually.

11. A method according to claim 3, wherein the object use of at least one of said plurality of content objects in one of said plurality of simulated playbacks is different to the object use of the same at least one content object in a different of said plurality of simulated playbacks.

12. A method according to claim 11, wherein said priority is determined in step b) in accordance with a statistical technique.

13. A method according to claim 11, wherein said priority is determined in step b) in accordance with a stochastic technique.

14. A method according to claim 13, wherein said stochastic technique includes a Monte Carlo technique.

15. A method according to claim 11, wherein said priority is determined in step b) in accordance with an object use, of said at least one of said plurality of content objects, which is averaged over said plurality of simulated playbacks.

16. A method according to claim 2, wherein determining said priority in step b) includes weighting the object use monitored for at least one of said plurality of content objects and determining said priority in accordance with said weighted object use.

17. A method according to claim 1, wherein said priority is determined in accordance with a predicted frequency of using at least one of said plurality of content objects in a playback.

18. A method according to claim 1, wherein said priority is determined in accordance with a size of at least one of said plurality of content objects in said playback.

19. A method according to claim 1, wherein said method includes determining an individual priority in step b) for each of said plurality of content objects.

20. A method according to claim 1, wherein said providing of the plurality of content objects in step a) includes generating at least one content object.

21. A method according to claim 1, wherein said priority is indicative of a priority of storing one or more content objects.

22. A method according to claim 1, wherein said priority is indicative of a priority of deleting at least part of one or more content objects.

23. A method according to claim 21, wherein said storing is storing in an object store which is a cache.

24. A method according to claim 1, wherein said plurality of content objects and said priority are stored in step c) on a record carrier.

25. A method according to claim 24, wherein said record carrier is an optical disc playable according to an optical disc format specification.

26. A method according to claim 24, wherein said record carrier is a magnetic hard disc.

27. A method according to claim 1, wherein each one of said plurality of content objects is stored in step c) in association with a respective priority.

28. A method according to claim 1, wherein each of said plurality of content objects represents at least one of the following: video data, image data, audio data, and a program.

29. An audiovisual product comprising a playback-device-readable medium having audiovisual content recorded thereon, wherein said audiovisual content includes a plurality of content objects and priority data operative when utilized by a playback device to indicate to the playback device a predicted use of at least one of said plurality of content objects in a playback of said audiovisual content.

30. An audiovisual product according to claim 29, wherein said audiovisual product is a record carrier.

31. An audiovisual product according to claim 30, wherein said record carrier is an optical disc playable according to an optical disc format specification.

32. An audiovisual product according to claim 29, wherein said audiovisual content is arranged to be streamed over a data link from a remote terminal.

33. An audiovisual product according to claim 29, wherein said priority data comprises a priority of storing one or more of said plurality of content objects.

34. An audiovisual product according to claim 29, wherein said priority data comprises a priority of deleting at least part of one or more of said plurality of content objects.

35. An audiovisual product according to claim 29, wherein said audiovisual product includes an association of each one of said plurality of content objects with respective priority data.

36. An audiovisual product according to claim 29, wherein said priority data comprises an individual priority for each of said plurality of content objects.

37. An audiovisual product according to claim 29, wherein said priority data is indicative of a predicted frequency of using at least one of said plurality of content objects in a playback.

38. An audiovisual product according to claim 29, wherein each of said plurality of content objects represents at least one of the following: video data, image data, audio data, and a program.

39. An audiovisual product according to claim 29, wherein said plurality of content objects is arranged to accompany a stream of audiovisual content provided in the playback.

40. An audiovisual product according to claim 29, wherein said plurality of content objects is arranged to be provided separately from a stream of audiovisual content provided in the playback.

41. Apparatus for performing playback of audiovisual content stored by an audiovisual product, wherein said audiovisual content includes a plurality of content objects and priority data indicative of a predicted use of at least one of said plurality of content objects in said playback, wherein said apparatus comprises:
a) a reader arranged to read content objects and respective priority data;
b) an object store arranged to temporarily store one or more content objects; and
c) an object handler arranged, in accordance with respective priority data, to store one or more content objects in said object store and/or to delete at least part of one or more content objects stored in said object store.

42. Apparatus according to claim 41, wherein said object store has a maximum object storage capacity and said object handler is arranged to delete one or more content objects already stored in said object store when there is one content object to be stored in the object store and if storing said one content object in the object store would cause said maximum object storage capacity to be exceeded.

43. Apparatus according to claim 41, wherein when said object store stores a plurality of content objects with respective priority data comprising different priorities, the object handler is arranged to delete from the object store the content object with a lowest priority amongst said stored content objects.

44. Apparatus according to claim 41, wherein when said object store stores a plurality of content objects with respective priority data indicative of equal priorities, the object handler is arranged to delete from the object store one of the content objects with the equal priority in accordance with a period of time of storing each of the content objects with the equal priorities in the object store.

45. Apparatus according to claim 41, wherein said object store is a cache.

46. Apparatus according to claim 41, wherein said reader is arranged to read a plurality of content objects and respective priority data from a record carrier.

47. Apparatus according to claim 46, wherein said record carrier is an optical disc playable according to an optical disc format specification.

48. Apparatus according to claim 41, wherein said reader is arranged to read a plurality of content objects and respective priority data from a data stream.

49. Apparatus according to claim 41, wherein said apparatus is arranged to receive audiovisual content provided over a data link from a remote terminal.

50. Apparatus according to claim 41, wherein said priority data comprises an individual priority for each of a plurality of content objects.

51. Apparatus according to claim 41, wherein each of said plurality of content objects represents at least one of the following: video data, image data, audio data, a program.

52. Apparatus according to claim 41, wherein said apparatus is arranged to playback audiovisual content.

53. Apparatus according to claim 41, wherein said reader is arranged to read a stream of audiovisual content accompanied by content objects and respective priority data.

54. Apparatus according to claim 41, wherein said reader is arranged to read content objects and respective priority data separately from a stream of audiovisual content.
